(19) United States
(12) Patent Application Publication
(10) Pub. No.: US 2022/0289231 A1
(43) Pub. Date: Sep. 15, 2022

(54) CONTROL DEVICE

(71) Applicant: HONDA MOTOR CO., LTD., Tokyo (JP)

(72) Inventors: Teruki TAKAHASHI, Tokyo (JP); Akihiro SEKINO, Tokyo (JP); Makoto NAKATSUKA, Tokyo (JP)

(73) Assignee: HONDA MOTOR CO., LTD., Tokyo (JP)

(21) Appl. No.: 17/678,552

(22) Filed: Feb. 23, 2022

(30) Foreign Application Priority Data
Mar. 12, 2021 (JP) 2021-040637

(51) Int. Cl. B60W 50/16; B60W 60/00

(52) U.S. Cl. CPC B60W 50/16; B60W 60/001; B60W 2050/143

(57) ABSTRACT

A control device includes: an acquisition unit configured to acquire history information of a past operation of a moving object; and a control unit configured to perform control, based on the history information, to notify a user of the moving object of an unexecuted function in the past operation among automatic-movement-related functions executable by the moving object in the past operation.

### CROSS REFERENCE TO RELATED APPLICATIONS

This application claims priority to Japanese Patent Application No. 2021-040637 filed on Mar. 12, 2021, the content of which is incorporated herein by reference.

### TECHNICAL FIELD

The present invention relates to a control device.

### BACKGROUND ART

In related art, there has been known a moving object (for example, a vehicle) having a plurality of functions related to automatic movement such as autonomous driving and driving assistance. In such a moving object, each function is executed during an operation of the moving object based on an operation performed on the moving object by a user (for example, a driver).

Even though there are functions that can be used at the time of the operation of the moving object, these functions are executed based on the operation performed by the user, and therefore, when the operation is not performed by the user, effects of the functions are not exhibited. In particular, it is difficult to execute a function that the user does not know or forgets. Therefore, opportunities for executing an automatic-movement-related function are reduced, and thus the moving object cannot be operated smoothly, and usability is reduced.

WO 2019/167257 describes a configuration in which, after autonomous driving or driving assistance is ended, information such as a time during which the autonomous driving is continued, a time during which automatic following is continued during the autonomous driving, a distance of traveling by the autonomous driving, the number of times when danger is detected and avoided during the autonomous driving, and an amount of CO₂ reduced by the autonomous driving is notified.

However, WO 2019/167257 does not explicitly describe decrease in opportunities to execute the automatic-movement-related function. Therefore, there is room for improvement in a process relative to the decrease in the opportunities to execute the automatic-movement-related function.

An object of the present invention is to provide a control device capable of promoting execution of an automatic-movement-related function and improving a smooth operation and usability of a moving object.

### SUMMARY OF INVENTION

An aspect of the present invention provides a control device includes: an acquisition unit configured to acquire history information of a past operation of a moving object; and a control unit configured to perform control, based on the history information, to notify a user of the moving object of an unexecuted function in the past operation among automatic-movement-related functions executable by the moving object in the past operation.

### BRIEF DESCRIPTION OF DRAWINGS

FIG. 1 is a block diagram of a control device mounted on a vehicle according to an embodiment of the present invention;

FIG. 2 is a flowchart showing a process of a control device according to a first embodiment;

FIG. 3 shows an example of notification contents displayed on a display device of a vehicle;

FIG. 4 shows a configuration of a network system according to a second embodiment; and

FIG. 5 is a block diagram showing hardware of a server.

### DESCRIPTION OF EMBODIMENTS

Hereinafter, embodiments of a control device of the present invention will be described with reference to the drawings. In the following description of the embodiments, examples in which a vehicle 100 such as an automobile serves as a moving object in the present invention will be described.

### First Embodiment

<Configuration of Vehicle>

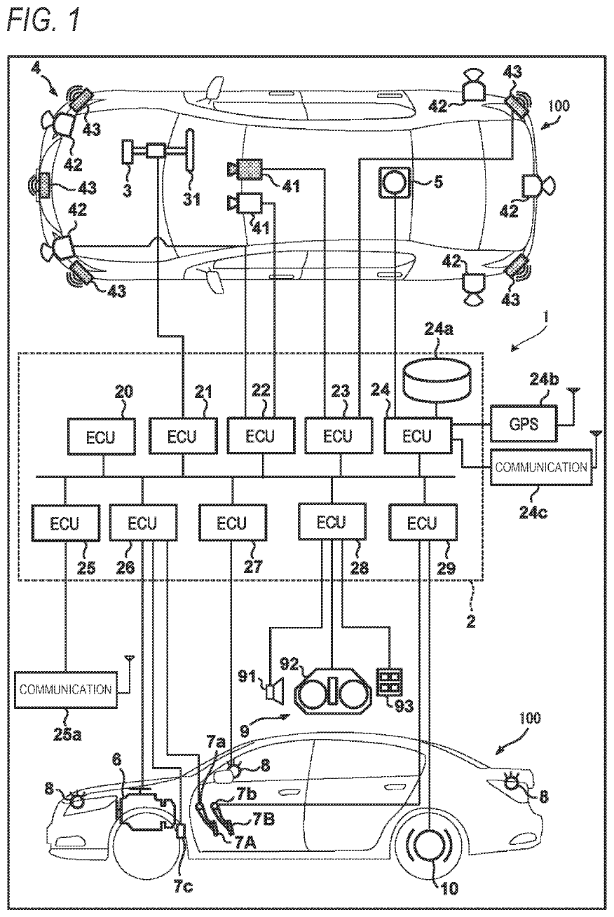

FIG. 1 is a block diagram of a vehicle control device 1 according to one embodiment of the present invention. The control device 1 controls each unit of the vehicle 100. In FIG. 1, an outline of the vehicle 100 is shown in a plan view and aside view. The vehicle 100 is, for example, a four-wheel passenger vehicle capable of automatic movement by autonomous driving. The autonomous driving may include assistant driving performed by an advanced driving assistance system.

As shown in FIG. 1, the control device 1 includes a control unit 2. The control unit 2 includes a plurality of electronic control units (ECUs) 20 to 29 communicably connected by an in-vehicle network. Each ECU includes a processor represented by a central processing unit (CPU), a storage device such as a semiconductor memory, an interface with an external device, and the like. The storage device stores programs to be executed by the processor, data to be used in processing performed by the processor, and the like. Each of the ECUs 20 to 29 may include a plurality of processors, storage devices, interfaces, and the like.

Hereinafter, functions and the like that the ECUs 20 to 29 are in charge of will be described. It should be noted that the number of ECUs and the functions that the ECUs are in charge of can be appropriately designed for the vehicle 100, and can be subdivided or integrated as compared with the present embodiment.

The ECU 20 executes control related to the autonomous driving of the vehicle 100. In the autonomous driving, at least one of steering and acceleration/deceleration of the vehicle 100 is subjected to automatic movement control. In a control example to be described later, both steering and acceleration/deceleration are subjected to the automatic movement control. In addition, the ECU 20 can access a database 24a, and stores information on travel functions of the vehicle 100 and information on travel history in the database 24a. The database 24a is an example of an acquisition unit that acquires history information of a past operation of a moving object.

The ECU 21 controls an electric power steering device 3. The electric power steering device 3 includes a mechanism that steers front wheels in accordance with a driving operation (steering operation) performed on a steering wheel 31 by the driver. The electric power steering device 3 also includes a motor that exerts a driving force for assisting the steering operation or automatically steering the front wheels, a sensor that detects a steering angle, and the like. When a driving state of the vehicle 100 is autonomous driving, the ECU 21 subjects the electric power steering device 3 to the automatic movement control in response to an instruction from the ECU 20, and thus controls a traveling direction of the vehicle 100.

The ECU 22 and the ECU 23 control detection units 41 to 43 that detect surrounding situations of the vehicle, and perform information processing on detection results.

The detection unit 41 is a camera that captures an image of the front of the vehicle 100 (hereinafter, also referred to as the camera 41). In the case of the present embodiment, two cameras are provided on a roof front portion of the vehicle 100. By analyzing an image captured by the camera 41, it is possible to extract a contour of a target or extract lane marking (white line or the like) of a lane on a road.

The detection unit 42 is a LiDAR (light detection and ranging) that detects a target around the vehicle 100 and measures a distance to the target (hereinafter, also referred to as the LiDAR 42). In the case of the present embodiment, five LiDARs 42 are provided, one at each corner of a front portion of the vehicle 100, one at a center of a rear portion, and one on each side of the rear portion.

The detection unit 43 is a millimeter wave radar that detects a target around the vehicle 100 and measures a distance to the target (hereinafter, also referred to as the radar 43). In the case of the present embodiment, five radars 43 are provided, one at a center of the front portion of the vehicle 100, one at each corner of the front portion, and one at each corner of the rear portion.

The ECU 22 controls one camera 41 and each LiDAR 42, and performs information processing on detection results thereof. The ECU 23 controls the other camera 41 and each radar 43, and performs information processing on detection results thereof. By providing two sets of devices for detecting the surrounding situations of the vehicle, reliability of the detection results can be improved, and by providing different types of detection units, namely cameras, LiDARs, and radars, surrounding environment of the vehicle can be analyzed in a multifaceted manner.

The ECU 24 controls a gyro sensor 5, a GPS sensor 24b, and a communication device 24c, and performs information processing on detection results or communication results thereof.

The gyro sensor 5 detects a rotational motion of the vehicle 100. A route of the vehicle 100 can be determined based on a detection result of the gyro sensor 5, a rotation speed of wheels, and the like. The GPS sensor 24b detects a current position of the vehicle 100. The communication device 24c performs wireless communication with a server that provides map information and traffic information, and acquires such information. The ECU 24 can access the database 24a of map information constructed in the storage device, and performs a search for a route from a current location to a destination, and the like. In addition, the database 24a holds information detected by various sensors, the information on the travel functions of the vehicle 100, the information on the traveling history, and the like. The communication device 24c may communicate not only with the server that provides map information or traffic information but also with a server that provides other services.

The ECU 25 includes a communication device 25a for vehicle-to-vehicle communication. The communication device 25a performs wireless communication with other vehicles in the vicinity and performs inter-vehicle information exchange.

The ECU 26 controls a power plant 6. The power plant 6 is a mechanism that outputs a driving force for rotating drive wheels of the vehicle 100, and includes, for example, an engine and a transmission. The ECU 26, for example, controls output of the engine in response to a driving operation (accelerator operation or acceleration operation) of a driver detected by an operation detection sensor 7a provided on an accelerator pedal 7A, or switches a gear stage of the transmission based on information such as a vehicle speed detected by a vehicle speed sensor 7c. When the driving state of the vehicle 100 is the autonomous driving, the ECU 26 subjects the power plant 6 to the automatic movement control in response to an instruction from the ECU 20, and thus controls acceleration and deceleration of the vehicle 100.

The ECU 27 controls a lighting device (a headlight, a taillight, or the like) including a direction indicator 8. In the case of the present embodiment, the direction indicators 8 are provided at the front portion, a door mirror, and the rear portion of the vehicle 100.

The ECU 28 controls an input and output device 9. The input and output device 9 outputs information to the driver and receives input of information from the driver.

An audio output device 91 notifies the driver of information by audio. A display device 92 notifies the driver of information by displaying an image. The display device 92 is disposed, for example, in front of a driver seat, and constitutes an instrument panel or the like. Here, the display device 92 may be a touch panel display in which a user interface that receives a user operation and a display that performs screen display are integrated. It should be noted that although the audio and the display are exemplified herein, the information may also be notified by vibration or light. The information may also be notified by combining a plurality of audio, display, vibration, and light. Further, different combinations or different notification modes may be used depending on a level of the information to be notified (for example, a degree of urgency). An input device 93 is a switch group that is disposed at a position enabling the driver to operate so as to issue an instruction to the vehicle 100, and an audio input device may be included therein.

The ECU 29 controls a brake device 10 and a parking brake (not shown). The brake device 10 is, for example, a disc brake device. The brake device 10 is provided on each wheel of the vehicle 100 to decelerate or stop the vehicle 100 by applying resistance to rotation of the wheel. For example, the ECU 29 controls an operation of the brake device 10 in response to a driving operation (brake operation) of the driver detected by an operation detection sensor 7b provided on a brake pedal 7B. When the driving state of the vehicle 100 is the autonomous driving, the ECU 29 subjects the brake device 10 to the automatic movement control in response to an instruction from the ECU 20, and thus controls deceleration and stop of the vehicle 100. The brake device 10 and the parking brake can also be operated to maintain a stopped state of the vehicle 100. In addition, w % ben the transmission of the power plant 6 includes a parking lock mechanism, such a mechanism can be operated to maintain the stopped state of the vehicle 100.

<Control>

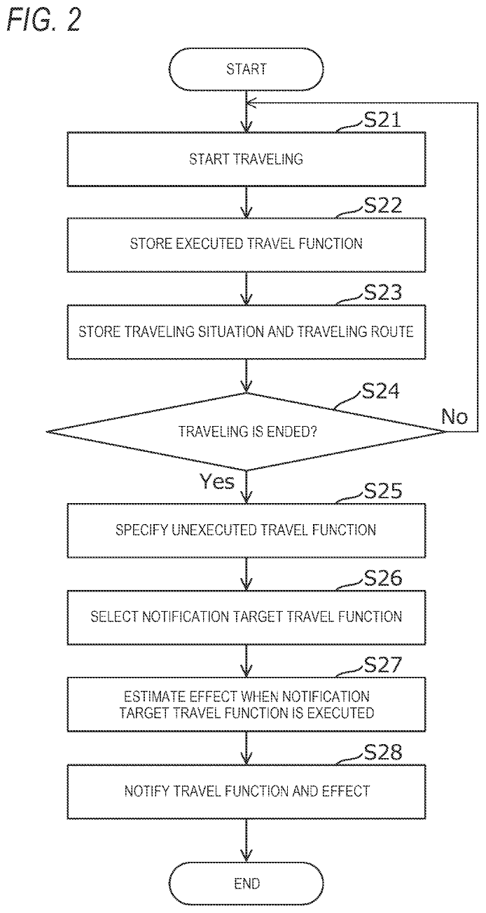

An example of a control process performed by the control device 1 will be described with reference to FIG. 2. It is assumed that the vehicle 100 of the present example is switched from autonomous driving to manual driving or from manual driving to autonomous driving in accordance with an instruction of a user or the like.

When an ignition switch of the vehicle 100 is pressed and the engine is started, the control device 1 starts traveling of the vehicle 100 in accordance with an instruction from the driver (step S21).

An instruction of the autonomous driving or the manual driving is issued by the driver via the input device 93, for example. Contents of control in the autonomous driving are not particularly limited. For example, it is assumed that there are a plurality of driving levels (levels 0 to 5) in the autonomous driving, and the level may be switched as appropriate according to the surrounding environment, a state of the driver, or the like. In addition, a configuration in which switching to manual driving is performed in stages according to the surrounding environment, the state of the driver, or the like may be employed.

Next, the control device 1 determines which function is actually executed among the travel functions included in the vehicle 100 during traveling of the vehicle 100, and stores the executed function in the database 24a (step S22).

The travel functions of the vehicle 100 are functions related to the autonomous driving and the assistant driving of the vehicle 100. The travel functions may include any function related to the autonomous driving and the assistant driving of the vehicle 100. For example, an autonomous driving function and an assistant driving function of the vehicle 100 may each serve as one travel function. In addition, each of the driving levels 0 to 5 of the vehicle 100 may serve as one travel function. In addition, an automatic follow-up function (adaptive cruise control system), a lane keeping assist function (lane keeping assist system), a constant speed traveling function, a lane changing function, an overtaking function, a branching function, a merging function, an obstacle avoidance function, a takeover function, and the like may each serve as one travel function.

Next, the control device 1 measures history information such as a traveling situation and a traveling route during the traveling of the vehicle 100, and stores information on the measured traveling situation and traveling route in the database 24a (step S23).

The traveling situation may include, for example, a congestion level of a traveled road, a traveling speed in a predetermined traveling section, a degree of a curve of the traveled road, a state of a surface of the traveled road, a continuous traveling time, a fuel consumption amount (remaining amount), a state of a passenger (an expression, an action, or the like), a travel distance, and the like. The travel route is measured, for example, based on the map information held in the database 24a and collected position information of the vehicle 100.

Next, the control device 1 determines whether driving of the vehicle 100 is ended (step S24). In the present example, whether the driving is ended is determined based on whether the vehicle 100 has arrived at the destination. The arrival at the destination is determined, for example, when the driver tries to leave the vehicle 100 and turns off the ignition switch (stops the engine). In addition, an object of the traveling of the vehicle 100 in the present example is to visit a predetermined tourist facility, and an expressway is used on a way to the target tourist facility.

In step S24, when it is determined that the driving is not ended (No in step S24), the control device 1 returns to step S21 and repeats each process.

On the other hand, in step S24, when it is determined that the driving is ended (Yes in step S24), the control device 1 refers to the executed travel function (step S22) stored in the database 24a, and specifies unexecuted travel functions in the currently ended operation among the travel functions included in the vehicle 100 (step S25).

Next, the control device 1 selects a target travel function to be notified to the driver of the vehicle 100 from the travel functions specified in step S25 (step S26).

For example, the control device 1 selects the travel function to be notified to the driver from the unexecuted travel functions based on attribute information of a route of the currently ended operation. The attribute information of the route of the operation is information that can be obtained from the map information, and includes, for example, information on a road type such as a general road or an expressway, information on whether the road is an urban road or a suburban road, information on whether the road is a road with a large number of curves, information on whether the road is a road with a large number of slopes (uphill slope or downhill slope), and the like.

As described above, the vehicle 100 travels with the predetermined tourist facility serving as the destination, and uses the expressway during the traveling. Therefore, for example, when the driver of the vehicle 100 does not use the autonomous driving function during the traveling on the expressway, the “autonomous driving function” may be selected as the notification target travel function.

Next, the control device 1 estimates an execution effect of the autonomous driving function in a case where it is assumed that the travel function (for example, the “autonomous driving function”) to be notified selected in step S26 is executed in the current operation (step S27).

The execution effect of the travel function can be estimated based on, for example, a travel distance of the vehicle 100, a travel time, fuel consumption, switching between the autonomous driving and the manual driving, switching timing of the driving levels, information on the vicinity of the vehicle 100 (presence or absence of another vehicle, a state of a road surface, and the like), a state of an occupant (expression, action, and the like).

Next, the control device 1 notifies the driver of the vehicle 100 of the notification target travel function selected in step S26 and the execution effect of the travel function estimated in step S27 (step S28). The notification to the driver is performed by, for example, image display on the display device 92. In the case of the present example, the display device 92 displays the “autonomous driving function” as the notification target travel function, and displays an “execution effect when the autonomous driving function is executed” as the execution effect of the travel function.

Although whether the vehicle has arrived at the destination is determined based on whether the ignition switch is turned off in the example described above, the determination is not limited thereto. For example, whether the vehicle has arrived at the destination may also be determined based on a get-on/get-off operation of the driver (release of a seat belt, closing of a window, opening of a door), an action of the driver (line of sight, visual line, voice), or the like. In addition, the determination may also be performed based on a combination of several such parameters.

Although timing when the travel function and the execution effect are notified, that is, the time when the driving is ended is the time when the vehicle 100 arrives at the destination in the example described above, the timing is not limited thereto. For example, the travel function and the execution effect may be notified when the vehicle 100 travels a predetermined distance, when the vehicle 100 travels for a predetermined time, when the vehicle 100 temporarily stops and waits for a traffic light, when the road type changes (when the vehicle 100 comes to a general road from the expressway), when the notification target travel function is changed from an executable state to an inexecutable state (becomes invalid), or the like.

### Display Example

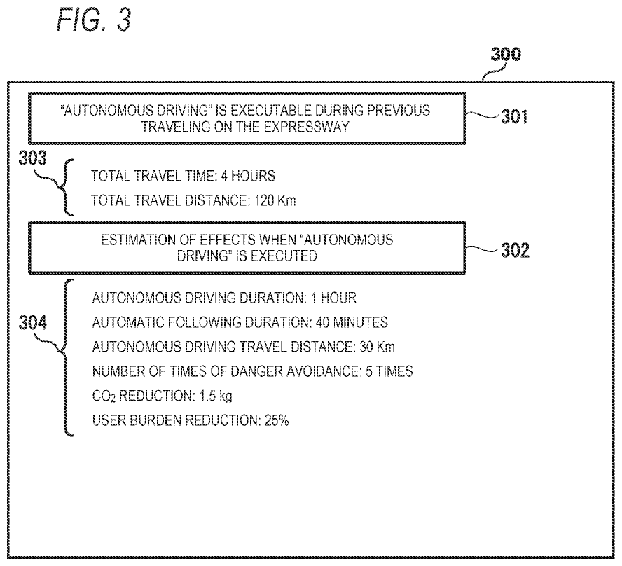

An example of the “travel function and execution effect” displayed on the display device 92 will be described with reference to FIG. 3. In this example, the “autonomous driving function” described in the description of FIG. 2 will be described as the notification target travel function, and the execution effect when the “autonomous driving function” is executed will be described as the execution effect.

As shown in FIG. 3, a screen 300 of the display device 92 includes a function notification field 301 where notification contents related to the travel function are displayed, and an effect notification field 302 where the execution effect of the travel function is displayed.

In the function notification field 301, a message notifying unexecuted travel functions among executable travel functions, for example, a message indicating that “‘autonomous driving’ is executable during previous traveling on the expressway” is displayed. In addition, in the effect notification field 302, a message notifying the execution effect of the travel function in the case where it is assumed that the travel function is executed during the current operation, for example, a message indicating “estimation of effects when ‘autonomous driving’ is executed” is displayed.

Below the function notification field 301, a travel information field 303 that displays overall information on the current traveling is provided. In the travel information field 303, for example, information of “total travel time: 4 hours” notifying that a travel time until the arrival at the destination is 4 hours, and information of “total travel distance: 120 km” notifying that a distance traveled this time is 120 km are displayed.

Below the effect notification field 302, an effect information field 304 that displays specific effect contents in the case where “autonomous driving” is executed is provided. In the effect information field 304, for example, in the case where the autonomous driving is executed, information of “autonomous driving duration: 1 hour” notifying that a time when the autonomous driving is continued on the expressway is 1 hour, information of “automatic following duration: 40 minutes” notifying that a time when automatic following is continued in the autonomous driving is 40 minutes, and information of “autonomous driving travel distance: 30 km” notifying that a distance traveled by the autonomous driving is 30 km are displayed. In addition, information of “number of times of danger avoidance: 5 times” notifying that the number of times when danger can be detected and avoided during the autonomous driving is 5 times, and information of “CO₂ reduction: 1.5 kg” notifying that an amount of CO₂ reduced by the autonomous driving is 1.5 kg are displayed. In addition, information of “user burden reduction: 25%” notifying that a burden on the driver can be reduced by 25% by the autonomous driving is displayed.

As described above, according to the control device 1, the driver can be notified of the travel function related to the autonomous driving or the assistant driving that is not executed since the driver does not know or forgets after the operation in which the travel function can be executed. Therefore, the driver can specifically grasp a situation where the travel function can be used in association with the past operation of the driver. As a result, the driver can be urged to execute the travel function related to the autonomous driving or the assistant driving included in the vehicle 100, and thus a smooth operation and usability of the vehicle 100 can be improved.

In addition, according to the control device 1, the effect obtained when it is assumed that the unexecuted travel function is executed in the past operation can also be notified together with the notification of the unexecuted travel function in the past operation. Therefore, the driver can specifically grasp the effect of the travel function in association with the past operation of the driver. As a result, the driver can be further strongly urged to execute the travel function related to the autonomous driving and the assistant driving.

Although the selection is performed based on the attribute information of the route in the ended operation (past operation) when the travel function to be notified to the driver is selected from the unexecuted travel functions in the control example and the display example of the control device 1 shown in FIGS. 2 and 3, the selection is not limited thereto, and may also be performed as follows.

For example, the control device 1 may select the travel function to be notified to the driver from the unexecuted travel functions based on the number of execution opportunities in the past operation. The number of execution opportunities means a length of time when execution is possible in the past operation, a length of distance where the execution is possible, the number of times when the execution is possible, and the like.

For example, when it is determined that there are a large number of opportunities to use the lane changing function in the past operation, the “lane changing function” is selected as the travel function to be notified to the driver in step S26 of FIG. 2. In this case, in the function notification field 301 of FIG. 3, for example, a message “‘lane changing function’ is executable in current traveling” is displayed. In addition, in the effect notification field 302, for example, a message “estimation of effect when ‘lane changing function’ is executed” is displayed. In addition, in the effect information field 304, for example, “number of times of lane changing: 5” is displayed.

In addition, for example, in a case where it is determined that there are a large number of opportunities to use the automatic following function (Adaptive Cruise Control: ACC) during the traveling on the expressway in the past operation, the “automatic following function” is selected as the travel function to be notified to the driver in step S26 of FIG. 2. In this case, in the function notification field 301 of FIG. 3, for example, a message “the automatic following function is executable on the previous expressway, following travel is enabled while an appropriate inter-vehicle distance is automatically maintained if the automatic following function is executed” is displayed. In addition, in the effect notification field 302, for example, a message “estimation of effect when ‘automatic following function’ is executed” is displayed. In addition, in the effect information field 304, for example. “automatic following duration: 40 minutes” is displayed. In this way, by preferentially notifying the driver of the travel function having a large number of opportunities to be executed in the actual operation of the driver, the driver can be urged to execute a useful travel function.

In addition, for example, the control device 1 may preferentially notify the driver of a travel function that the driver has no license to execute among the unexecuted travel functions. The travel functions of the vehicle 100 include standard travel functions that can be freely executed by the driver and additional option travel functions that require the driver to acquire license for execution. For example, a function related to safety may be a standard travel function, and a function related to comfort or the like may be an additional option travel function. In order to acquire the license for execution, payment of a fee or the like is required. The additional option travel function is a function to be charged. In this way, by preferentially notifying the driver of the travel function that the driver has no license to execute, the driver can be urged to acquire the license of the travel function, and thus the opportunities to execute the travel function related to the autonomous driving and the assistant driving can be increased.

In addition, for example, the control device 1 may preferentially notify the driver of a travel function that the driver has license to execute among the unexecuted travel functions. Since a travel function that does not require the driver to acquire new license, for example, a standard travel function that can be freely executed by the driver or an additional option travel function whose license is already acquired by the driver is preferentially notified to the driver, the opportunities to execute the travel function related to the autonomous driving and the assistant driving can further be increased.

In addition, for example, the control device 1 may select the travel function to be notified to the driver from the unexecuted travel functions based on a situation of the past operation. The operation situation refers to an actual driving situation, and includes, for example, a traffic congestion level of a road, a traveling speed, a degree of curve of the road, a continuous driving time, and the like.

For example, when it is determined that there is an opportunity to use the lane keeping function (Lane Keeping Assistant System: LKAS) in a past traffic congestion situation, the “lane keeping function” is selected as the travel function to be notified to the driver in step S26 of FIG. 2. In this case, in the function notification field 301 of FIG. 3, for example, a message “the lane keeping function is executable during the past traffic congestion, traveling can be performed in a state where hands are released from the steering wheel if the lane keeping function is executed” is displayed. In addition, in the effect notification field 302, for example, a message “estimation of effect when ‘lane keeping function’ is executed” is displayed. In addition, in the effect information field 304, for example, “lane keeping duration: 20 minutes” is displayed. As described above, since the travel function that is useful in the actual operation situation of the driver is preferentially notified to the driver, a useful travel function can be grasped for each operation situation in association with the past operation situation of the driver.

In addition, for example, the control device 1 may select the travel function to be notified to the driver from the unexecuted travel functions based on attribute information of the driver. The attribute information of the driver includes, for example, address, gender, age, hobby and preference, schedule, and the like of the driver.

For example, based on the age of the driver, a function of notifying surrounding danger may be preferentially selected and notified for an elderly person. In addition, a function of preventing excessive speed increase may be preferentially selected and notified for a young person. When the “function of notifying danger” is selected, it is possible to notify the driver of a message such as, for example, “please pay attention to the pedestrian ahead who may cross the road” or “please pay attention to the swaying vehicle traveling ahead”. In addition, when the “function of preventing excessive speed increase” is selected, for example, it is possible to notify a message that warns excessive speed increase when an amount of operation performed on the accelerator pedal by the driver increases. In addition, it is also possible to notify a message that warns excessive speed increase when the number of other vehicles traveling on the road is small while the speed is increased.

In addition, for example, a frequently-used travel function for each attribute or a highly-evaluated travel function for each attribute may be statistically calculated, and a travel function that matches the attribute of the driver may be selected and notified. As a result, a useful travel function can be preferentially notified according to attributes of each driver.

### Second Embodiment

In the first embodiment, the control device 1 specifies, estimates, and notifies the travel function in the vehicle 100. In a second embodiment, a form of a network system including the vehicle 100 will be described.

<System Configuration>

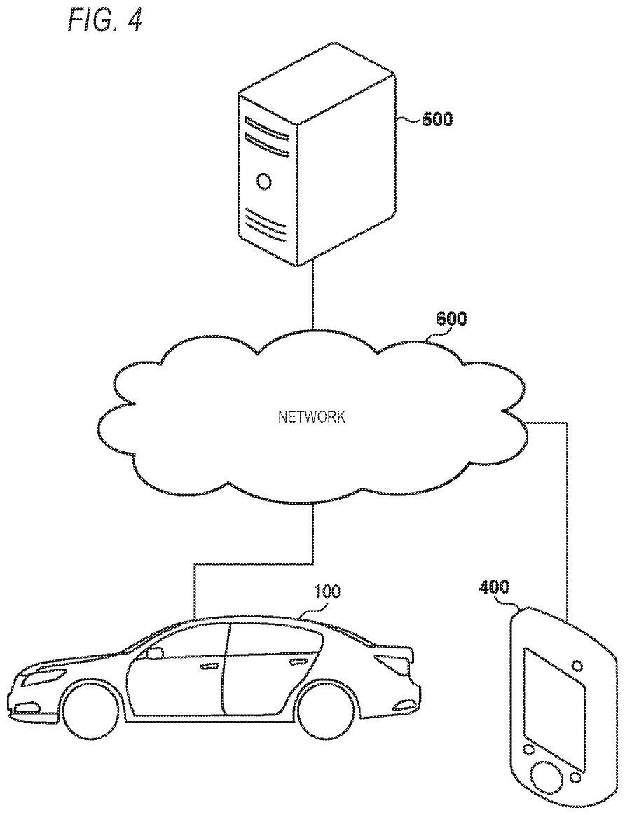

FIG. 4 shows a configuration example of the network system according to the present embodiment. The network system of the present embodiment includes the vehicle 100, a portable terminal 400, and a server 500. In addition, the vehicle 100, the portable terminal 400, and the server 500 are communicably connected to each other via a network 600.

The portable terminal 400 is, for example, a mobile phone, a smartphone, a mobile terminal, or the like. The portable terminal 400 includes a communication unit configured to communicate with an external device, a display unit configured to display various types of information, and an input unit configured to receive an operation of the driver. The server 500 is an information processing device. The server 500 performs various processes in response to requests from the vehicle 100 and the portable terminal 400, and provides information. The network 600 corresponds to, for example, the Internet. A communication standard thereof, whether the network 600 is wired or wireless, and the like are not particularly limited. It should be noted that although one device is shown for each device in FIG. 4, the number of devices is not limited thereto, and a plurality of devices may be included.

In the present embodiment, in a system configuration shown in FIG. 4, the processes shown in FIG. 2 are shared among the devices. The processes of specification, selection, and estimation in steps S25 to S27 of FIG. 2 are performed by the server 500. At this time, the vehicle 100 provides the information stored in steps S22 and S23 to the server 500. The provision here may be performed periodically, or may be performed when the stored information reaches a predetermined size.

In addition, the notification process in step S28 of FIG. 2 is performed in the portable terminal 400. The information notified by the portable terminal 400 is transmitted from the server 500. The server 500 transmits selected and estimated information to the portable terminal 400 via the network 600. As a notification method, the server 500 may be accessed and displayed from a web browser (not shown) included in the portable terminal 400, or the server 500 may notify an application (not shown) installed in the portable terminal 400 to perform display.

Alternatively, a personal computer (PC) serving as an information processing device may issue a request to the server 500, and the PC may check results of the selection and the estimation. The configuration at this time may be a configuration in which display is performed via a web browser (not shown) installed in the PC, or a configuration in which a dedicated application is installed in the PC so as to perform the check.

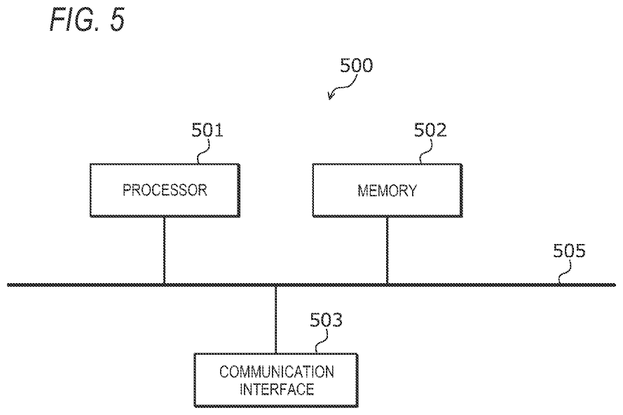

FIG. 5 shows a hardware configuration of the server 500. As shown in FIG. 5, the server 500 includes a processor 501, a memory 502, and a communication interface 503. The processor 501, the memory 502, and the communication interface 503 are connected by, for example, a bus 505.

The processor 501 is a circuit that performs signal processing, and is, for example, a central processing unit (CPU) that controls the entire server 500. The processor 501 may be implemented by another digital circuit such as a field-programmable gate array (FPGA) or a digital signal processor (DSP). The processor 501 may also be implemented by combining a plurality of digital circuits.

The memory 502 includes, for example, a main memory and an auxiliary memory. The main memory is, for example, a random access memory (RAM). The main memory is used as a work area of the processor 501. The auxiliary memory is, for example, a non-volatile memory such as a magnetic disk or a flash memory. Various programs for operating the server 500 are stored in the auxiliary memory. The programs stored in the auxiliary memory are loaded into the main memory and executed by the processor 501. The auxiliary memory may also include a portable memory removable from the server 500. Examples of the portable memory include a universal serial bus (USB) flash drive, a memory card such as a secure digital (SD) memory card, an external hard disk drive, and the like.

The communication interface 503 is a communication interface that performs communication with the outside of the server 500 (for example, the vehicle 100 or the portable terminal 400). The communication interface 503 communicates with the vehicle 100 and the portable terminal 400 via the network 600. The communication interface 503 is controlled by the processor 501.

In the case of the network system having such a configuration, similarly to the first embodiment, the driver can still be urged to execute the travel function related to the autonomous driving or the assistant driving included in the vehicle 100, and thus the smooth operation and the usability of the vehicle 100 can be improved.

Although the embodiments of the present invention have been described above, the present invention is not limited to the above-described embodiments, and modifications, improvements, and the like can be made as appropriate.

In addition, for example, although an example in which the moving object is the vehicle has been described in the above-described embodiment, the present invention is not limited thereto. The concept of the present invention can be applied not only to a vehicle but also to a robot, a ship, an aircraft, and the like that are provided with a drive source and movable by power of the drive source.

In addition, at least the following matters are described in the present specification. It should be noted that although constituent elements corresponding to those in the above-described embodiments are shown in parentheses, the constituent elements are not limited thereto.

(1) A control device includes: an acquisition unit (database 24a) configured to acquire history information of a past operation of a moving object; and

a control unit (ECU 20) configured to perform control, based on the history information, to notify a user of the moving object of an unexecuted function in the past operation among automatic-movement-related functions executable by the moving object in the past operation.

According to (1), by notifying a user of the automatic-movement-related function that is not executed since the user does not know or forgets after the operation in which the function is executable, the user can specifically grasp a situation where the function can be used in association with the past operation of the user. As a result, the user can be urged to execute the automatic-movement-related function, and thus a smooth operation and usability of the moving object can be improved.

(2) The control device according to (1),

in which the control unit performs control to notify the user of the unexecuted function, and an effect of the unexecuted function when it is assumed that the unexecuted function is executed in the past operation.

According to (2), by notifying the user of the effect obtained when it is assumed that the unexecuted function in the past operation is executed in the past operation, the user can specifically grasp the effect of the function in association with the past operation of the user, so that the user can be more strongly urged to execute the automatic-movement-related function.

(3) The control device according to (1) or (2),

in which the control unit performs control to notify the user of a function selected based on the number of execution opportunities in the past operation among the unexecuted functions.

According to (3), by preferentially notifying the user of the function having a large number of opportunities to be executed in the actual operation of the user, the user can be urged to execute a more useful function.

(4) The control device according to any one of (1) to (3),

in which the control unit performs control to preferentially notify the user of a function that the user has no license to execute among the unexecuted functions.

According to (4), since the user can be urged to acquire the license of the automatic-movement-related function, opportunities to execute the automatic-movement-related function are increased, and thus the smooth operation and the usability of the moving object can be improved.

(5) The control device according to any one of (1) to (3),

in which the control unit performs control to preferentially notify the user of a function that the user has license to execute among the unexecuted functions.

According to (5), since the user can be urged to execute the automatic-movement-related function that is executable even without newly acquiring license, the user can be more strongly urged to execute the automatic-movement-related function, and thus the smooth operation and the usability of the moving object can be improved.

(6) The control device according to any one of (1) to (5),

in which the control unit performs control to notify the user of a function selected based on a situation of the past operation among the unexecuted functions.

According to (6), the user can be preferentially notified of a function that is useful in an actual operation situation of the user, and thus the user can grasp the useful function for each operation situation in association with the past operation situation of the user.

(7) The control device according to any one of (1) to (6), in which the control unit performs control to notify the user of a function selected based on attribute information of a route of the past operation among the unexecuted functions.

According to (7), the user can be preferentially notified of a function that is useful regarding an attribute of an actual operation route of the user, and thus the user can grasp the useful function for each attribute of the operation route in association with the attribute of the past operation route of the user.

(8) The control device according to any one of (1) to (7),

in which the control unit performs control to notify the user of a function selected based on attribute information of the user among the unexecuted functions.

According to (8), the user can be preferentially notified of a function that is useful regarding the attribute of the user.

What is claimed is:

1. A control device comprising:
an acquisition unit configured to acquire history information of a past operation of a moving object; and
a control unit configured to perform control, based on the history information, to notify a user of the moving object of an unexecuted function in the past operation among automatic-movement-related functions executable by the moving object in the past operation.

2. The control device according to claim 1,
wherein the control unit performs control to notify the user of the unexecuted function, and an effect of the unexecuted function w % ben it is assumed that the unexecuted function is executed in the past operation.

3. The control device according to claim 1,
wherein the control unit performs control to notify the user of a function selected based on the number of execution opportunities in the past operation among the unexecuted functions.

4. The control device according to claim 1,
wherein the control unit performs control to preferentially notify the user of a function that the user has no license to execute among the unexecuted functions.

5. The control device according to claim 1,
wherein the control unit performs control to preferentially notify the user of a function that the user has license to execute among the unexecuted functions.

6. The control device according to claim 1,
wherein the control unit performs control to notify the user of a function selected based on a situation of the past operation among the unexecuted functions.

7. The control device according to claim 1,
wherein the control unit performs control to notify the user of a function selected based on attribute information of a route of the past operation among the unexecuted functions.

8. The control device according to claim 1,
wherein the control unit performs control to notify the user of a function selected based on attribute information of the user among the unexecuted functions.
